(19) United States
(12) Patent Application Publication
(10) Pub. No.: US 2003/0103242 A1
(43) Pub. Date: Jun. 5, 2003

(54) Facsimile apparatus and method of storing image data in facsimile apparatus

(75) Inventor: Yoshifumi Tanimoto, Hirakata-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/287,849

(22) Filed: Nov. 5, 2002

(30) Foreign Application Priority Data
Dec. 4, 2001 (JP) 2001-369699

(51) Int. Cl. H04N 1/00

(52) U.S. Cl. 358/402; 358/400

(57) ABSTRACT

A facsimile apparatus includes a unit that transmits or receives image data, a storage unit that stores transmitted and received image data in an archive device located in or out of the facsimile apparatus by specifying a storage location, and a storage location memory unit that stores an image data storage location corresponding to a record of a communication management log generated in transmitting or receiving image data.

### BACKGROUND OF THE INVENTION

1. Field of the Invention

The present invention relates to a facsimile apparatus and a method of storing image data, and more particularly to a facsimile apparatus having a function of storing transmitted or received image data and a method of storing transmitted or received image data.

2. Description of the Related Art

A terminal device for archiving, which is capable of receiving e-mails, is connected to a facsimile apparatus through networks for storing transmitted or received image data to an outside memory unit. Every time transmitting or receiving image data, a facsimile apparatus records activity journal information in e-mail text and attach transmitted or received image data in the e-mail, and then transmits the e-mail to the terminal device for archiving. The facsimile apparatus is then capable of storing transmitted or received image data safely to an outside memory unit, without exceeding the capacity of its own memory unit.

When an operator searches a document from many documents stored in the terminal device for archiving, an incoming e-mail history field is shown on the terminal device's display using client software for transmitting or receiving e-mails, which is installed in the terminal device for archiving. The operator then opens the e-mail by checking the transmission or reception time of the document, and locates the desired image data based on the activity journal information described in the e-mail text.

Since image data information stored in the terminal device for archiving is located in the main text of an e-mail, an operator has to open the e-mail and display its main text for confirming the content. Thus, it takes much time and trouble to search a desired document or image data.

### SUMMARY OF THE INVENTION

It is an advantage of the present invention to provide a facsimile apparatus, in which an operator, etc. may easily employ and manage stored transmitted or received image data.

It is another advantage of the present invention to provide a method of storing image data in the facsimile apparatus, in which an operator, etc. may easily employ and manage transmitted or received image data.

According to a first aspect of the present invention, a facsimile apparatus includes a unit that transmits or receives image data, a storage unit that stores transmitted and received image data in an archive device located in or out of the facsimile apparatus by specifying a storage location, and a storage location memory unit that stores information about the location of the image data stored (hereafter called a storage location) specified by a storage means corresponding to a record of a communication management log generated in transmitting or receiving the image data. Then, a document can be easily located, since the storage location as well as the communication management log is displayed or printed.

According to a second aspect of the present invention, the facsimile apparatus further includes a communication management log output unit that outputs the storage location, which the storage location memory unit stores corresponding to the record of the communication management log. Thus, a document can be easily located as the storage location as well as the communication management log is displayed corresponding to the record of the communication management log.

According to a third aspect of the present invention, in the facsimile apparatus as described above, the archive device is a HTTP server, the storage location memory unit stores the communication management log and the storage location corresponding to the respective records of the communication management logs as HTML files and also stores the storage location in hyperlink, and the communication management log output unit outputs the HTML file with a browser. Thus, a document can be easily located by choosing the URL shown on the display with a pointer.

According to a fourth aspect of the present invention, a facsimile apparatus includes a unit that transmits or receives image data, a unit that stores transmitted or received image data in an archive device located local or remote to the facsimile apparatus by specifying a storage location, and a memory unit that stores data in a storage location corresponding to given information (notation). Thus, a document can be easily located by displaying or printing given information and a storage location.

### BRIEF DESCRIPTION OF THE DRAWINGS

FIG. 1 is a block diagram illustrating a configuration of a facsimile apparatus in a preferred embodiment of the present invention.

FIG. 2 is a diagram illustrating an example of network environment that the facsimile apparatus is connected in the preferred embodiment of the present invention.

FIG. 3 is a diagram illustrating an example of a communication management log file in a first embodiment.

FIG. 4 is a flow chart illustrating an operation when the facsimile apparatus in the first embodiment stores image data in an archive device.

FIG. 5 is a flow chart illustrating an operation when the facsimile apparatus in the first embodiment displays the communication management log file.

FIG. 6A is a diagram illustrating an example of a display for requesting operators to specify the process of image data acquired from the archive device.

FIG. 6B is a diagram illustrating an example of a display for requesting operators to specify the transfer destination of image data acquired from the archive device.

FIG. 7 is a flow chart illustrating an operation when a facsimile apparatus in a second embodiment stores image data in the archive device.

FIG. 8 is a diagram illustrating an example of a display for requesting operators to input given information added to image data stored in the archive device.

FIG. 9 is a diagram illustrating an example of a table, in which each image data is stored in a storage location correspond to given information.

FIG. 10 is a flow chart illustrating an operation of facsimile apparatus in case that an operator, etc. specifies the process of image data stored in the archive device.

FIG. 11 is an explanatory diagram in case that the archive device is installed in the facsimile apparatus.

### DETAILED DESCRIPTION OF THE INVENTION

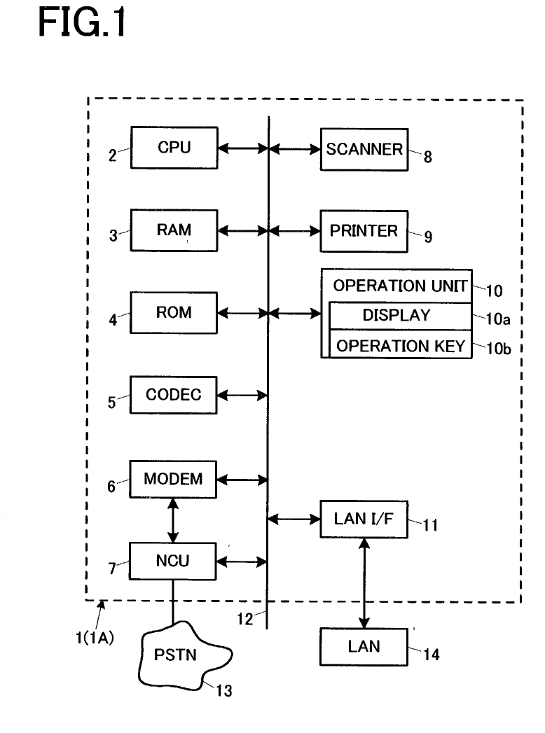

Hereinafter, a facsimile apparatus and a method of storing image data in a preferred embodiment of the present invention will be described with reference to the drawings. FIG. 1 shows a configuration example of the facsimile apparatus. The facsimile apparatus 1 includes a CPU (Central Processing Unit) 2, a RAM (Random Access Memory) 3, a ROM (Read Only Memory) 4, a CODEC 5, a MODEM 6, a NCU (Network Control Unit) 7, a scanner 8, a printer 9, an operation unit 10, and a LAN I/F (Local Area Network Interface) 11, which are connected by a bus 12 so as to communicate each other.

The CPU 2 controls each part of the facsimile apparatus 1 based on a predetermined program.

The RAM 3 is functioned as a memory unit for storing telephone numbers, mail addresses, and communication management log files described later in advance and for storing data that is stored temporarily.

The ROM 4 stores various programs in order that the CPU 2 may control each part of the facsimile apparatus 1.

The CODEC 5 encodes or decodes image data in conformity with encoding schemes. For example, it encodes image data in a document scanned by the scanner 8 in conformity with MH (Modified Huffman), MR (Modified Read), and MMR (Modified Modified Read) encoding schemes for transmission, and decodes image data received from outside. Moreover, image data is generally encoded or decoded in conformity with TIFF (Tagged Image File Format) or PDF (Portable Document Format) in attaching image data in e-mail.

The MODEM 6 modulates data to be transmitted or demodulates received data in conformity with ITU-T (International Telecommunication Union) V.34 or the like.

The NCU 7 is a network control unit that controls phone lines for making calls or breaking the connection, and is connected to a PSTN (Public Switched Telephone Network) 13.

The scanner 8 has the function of scanning image in a document, and outputs image data such as binary format image data to a predetermined unit on demands from the CPU 2.

The printer 9, such as an electrophotographic type printer, prints received image data on a recording paper, and then discharges the recording paper. More precisely, the printer 9 prints image data in a document scanned by the scanner 8 or image data received through a facsimile or an Internet facsimile on a recording paper on demands from the CPU 2.

The operation unit 10 has a display 10a that shows the condition of the facsimile 1 and operator guidance. The operation unit 10 also includes a plurality of operation keys 10b for inputting telephone number, addressing with speed dial, scanning documents, and changing reversing display on the display 10a. The facsimile apparatus 1 is operated through the operation unit 10.

The LAN I/F 11 has an interface for LAN 14, so that the LAN 14 and the facsimile apparatus 1 are connected so as to communicate.

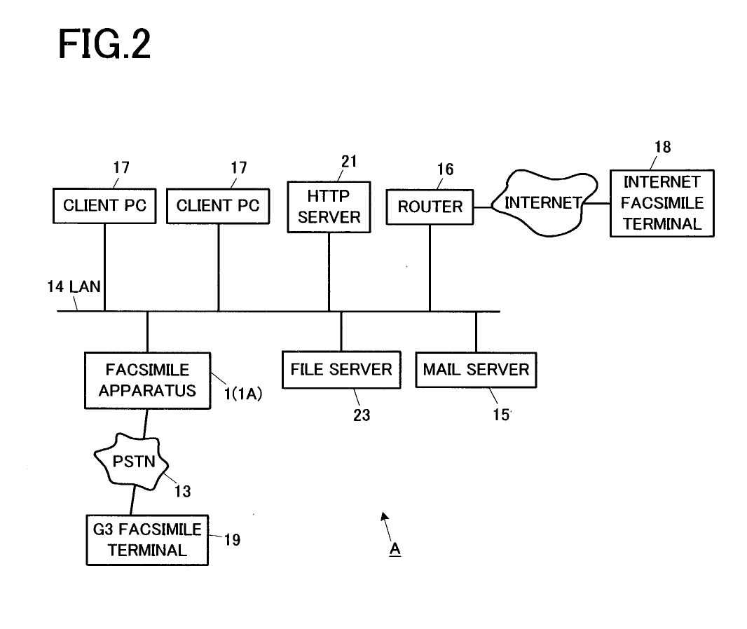

For example, the facsimile apparatus 1, as described above, is used in a network environment A as illustrated in FIG. 2. More precisely, the facsimile apparatus 1 is connected to a mail server 15, a router 16, a client PC 17 provided for the mail server 15 and an HTTP (Hypertext Transfer Protocol) server 21, the HTTP server 21 and a file server 23 used as archive devices so as to communicate with each other through the LAN 14. Thus, the facsimile apparatus 1 is capable of transmitting or receiving image data to or from an Internet facsimile terminal 18 through a mail server 15 and Internet, or a G3 facsimile terminal 19 through a PSTN 13.

Moreover, the facsimile apparatus 1 has the facsimile function of transmitting and receiving image data encoded in conformity with the MR, MMR, JPEG (Joint Photographic Experts Group) coding schemes, the Internet facsimile function of transmitting or receiving image data attached in an e-mail after being encoded in conformity with the one of coding scheme such as TIFF and PDF, using TCP/IP (Transmission Control Protocol/Internet Protocol) that is an Internet standard protocol, the function of transmitting or receiving a HTML (Hypertext Markup Language) file to or from the HTTP server 21, the browser function of displaying a HTML file, and the HTTP server function of retaining HTML files and accessing an appropriate HTML file on demands from the client PC 17.

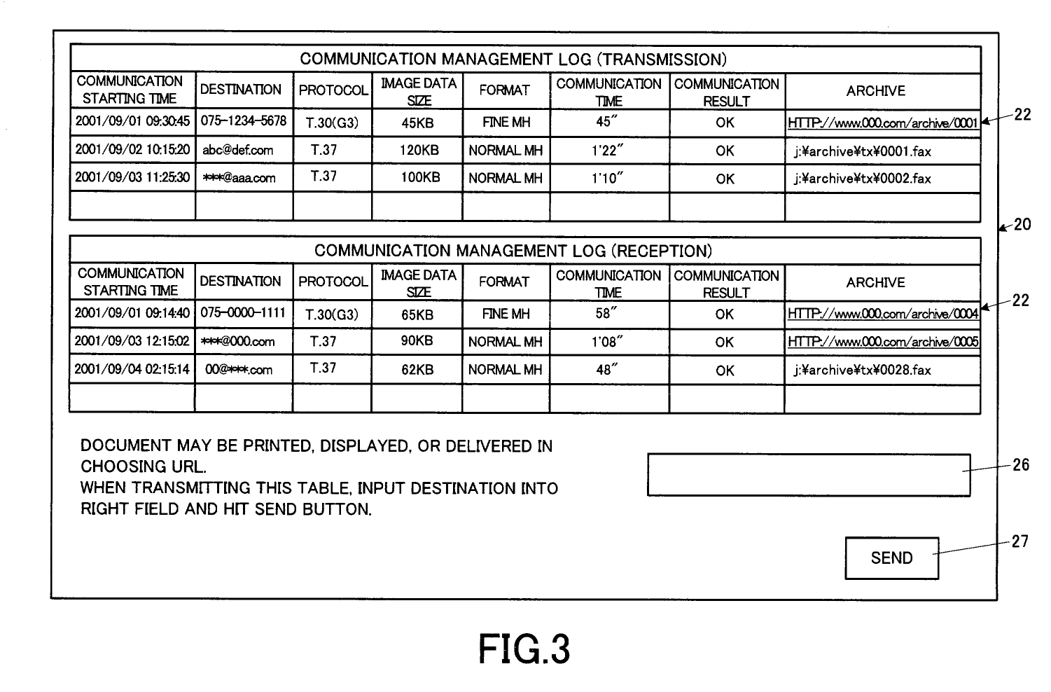

Furthermore, when transmitting and receiving image data, the facsimile apparatus 1 generates a communication management log file 20 in HTML format, in which a communication management log 22, a destination input field 26, and a send button 27 are shown on the display 10a or the display of PC 17 with a browser, as illustrated in FIG. 3. The facsimile apparatus 1 also updates the generated communication management log file 20 by adding records successively and stores then in a predetermined area of the RAM 3. As illustrated in the drawings, the communication management log 22 stores activity journal information in each field such as a “communication time” field or a “destination” field, and also stores a storage location of image data stored in the archive devices (the HTTP server 21, the file server 23) in an “archive” field, correspond to each record (each line in the communication management log 22). Additionally, when an operator inputs destination information such as an e-mail address in the destination input field 26 and chooses the send button 27, the facsimile apparatus 1 transmits the communication management log file 20 to the destination chosen by the operator in advance.

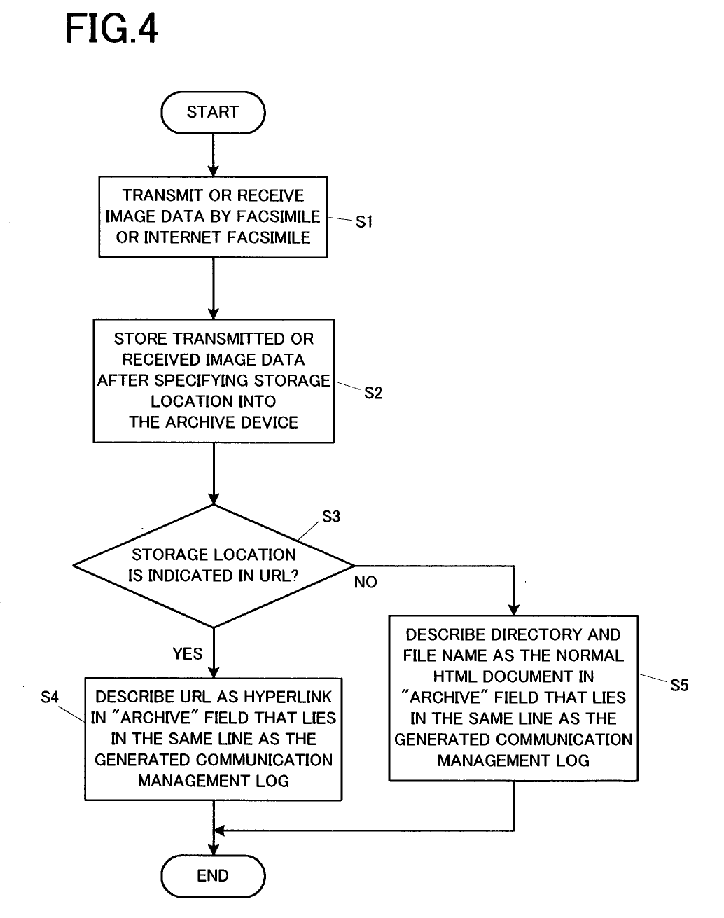

Next, the operation in case that the facsimile apparatus 1 stores image data in the archive devices 21 and 23 in transmitting and receiving image data will be described with reference to the flow chart of FIG. 4. The operation is carried out on instructions from the CPU 2 based on a control program stored in the ROM 4 of the facsimile apparatus 1. Moreover, the storage location of image data, the HTTP server 21 or the file server 23 described later, is automatically determined by the operator settings in the facsimile apparatus 1.

When transmitting and receiving image data via facsimile or the Internet (S1), the facsimile apparatus 1 stores transmitted and received image data in the HTTP server after specifying a URL (Uniform Resource Locators) as a storage location or stores the image data in the file server 23 after specifying a directory and a file name as a storage location (S2).

When a storage location is shown in URL (S3), the CPU 2 describes the URL as hyperlink in the “archive” field located in the same line as the generated record (S4) for storing the URL corresponding to the communication management log 22 generated in transmitting and receiving image data (S1). When a storage location is shown in a directory and a file name (S3), the CPU 2 identifies a directory and a file name as an usual HTML document in the “archive” field located in the same line as the generated record likewise (S5), for storing the directory and the file name corresponding to the generated communication management log 22.

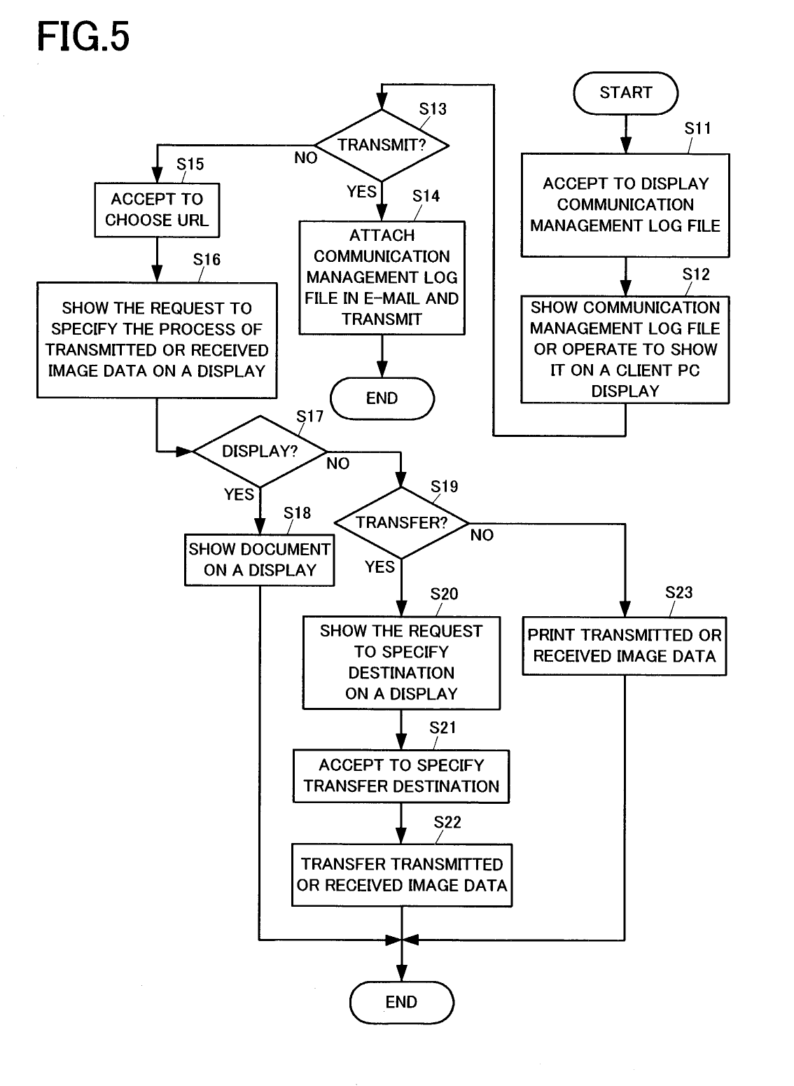

Next, the case of displaying, printing, or transferring image data stored in the HTTP server 21 or the file server 23 as described above will be described with reference to the flow chart of FIG. 5. The operation is also carried out on instructions from the CPU 2 based on a control program stored in the ROM 4 of the facsimile apparatus 1.

First, when an operator operates the operation unit 10 or the client PC 17 for displaying the communication management log file 20, the facsimile apparatus 1 accepts it (S11), shows the communication management log file 20 on a display 10a using a browser as illustrated in FIG. 3 or shows the communication management log file 20 on a display using a browser installed in the client PC 17 after transferring it to the client PC 17. The display 10a, which shows the content of communication management log file 20, includes the destination input field 26 and the send button 27 as well as the communication management log 22, and shows a URL notation in a storage location of transmitted and received image data shown in the “archive” field as hyperlink (S12).

When an operator inputs destination information such as an e-mail address in the destination input field 26 and chooses the send button 27 for transferring the communication management log file 20, the facsimile apparatus 1 determines that the communication management record log file 20 is transmitted to the input destination (S13), and transmits the communication management log file 20 with a HTML mail to the destination (S14).

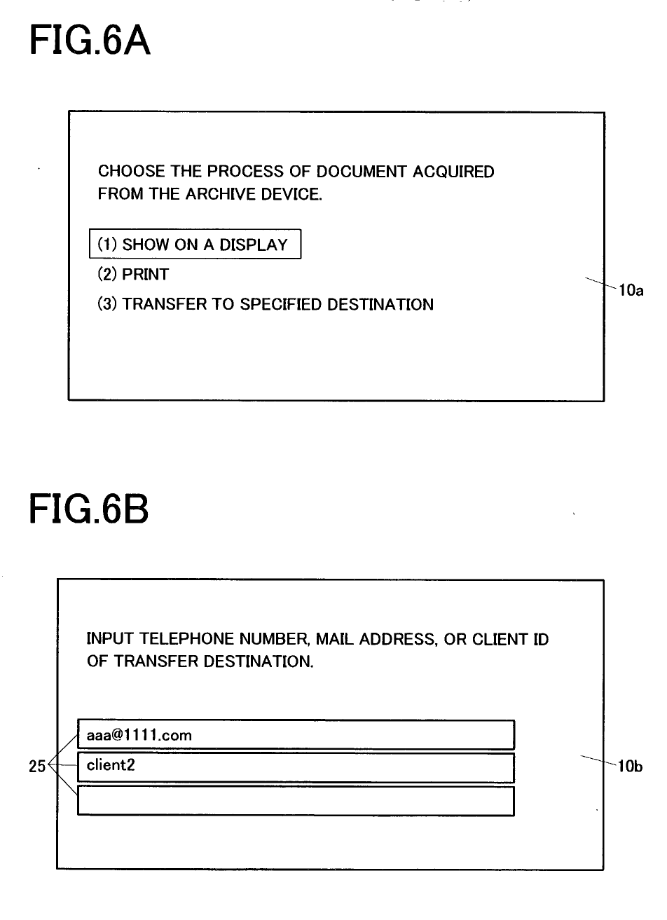

Meanwhile, when an operator chooses an URL indicated as hyperlink in the “archive” field with a pointer (not shown in the drawings) without inputting the destination information in the destination input field 26 in S13, the facsimile apparatus 1 accepts it (S15), and shows the screen for requesting operators to specify the process of transmitted or received image data, for example the choice of “(1) show on a display”, “(2) print”, or “(3) transfer to specified destination” is shown on the display 10a in order for an operator to choose the operation as illustrated in FIG. 6A, or transmits the appropriate display information to the client PC 17 so as to show it on the client PC 17 display (S16).

When an operator chooses “(1) show on a display” (S17), a transmitted or received document (image data) is shown on the display 10a or the display information is transmitted so as to show the document on the client PC 17 display (S18). When an operator chooses “(3) transfer to specified destination” (S19), the facsimile apparatus 1 shows the screen for requesting operators to specify a transfer destination, for example the screen for requesting operators to input telephone number and e-mail address of transfer destination as illustrated in FIG. 6B, or transmits the display information in order to show it on the client PC 17 display (S20). When an operator inputs destination information such as a telephone number, the facsimile apparatus 1 accepts it (S21) and transfers the transmitted or received image data to or from the specified address (S22). Moreover, when an operator chooses “(2) print”, the transmitted or received image data is printed in the printer 8 (S23).

As described above, it is apparent that the facsimile apparatus 1 stores image data in a transmitted or received document after giving a URL to the HTTP server 21 or giving a directory or a file name to the file server 23. If an operator shows the communication management log file 20 on the display 10a after conducting a predetermined operation or operates from the client PC 17 when users need a transmitted or received document, an appropriate document can be easily located from a storage location displayed correspond to the record of the communication management log 22 in the communication management log file 20 after showing it on the client PC 17 display.

Moreover, as a URL notation that shows a displayed storage location is indicated in hyperlink, an appropriate document can be easily shown on the display 10a after choosing the notation by a pointer, printed the document on the printer 8, or transferred it to a desired destination.

Furthermore, as the communication management log file 20 can be easily transmitted to a desired destination in a simple way as described in S14, users of the terminal device that is the destination of the communication management log file may know the storage location of transmitted or received data, or may easily acquire transmitted or received data after choosing a URL in hyperlink.

Hereinafter, the facsimile apparatus in a second embodiment will be described. As illustrated in FIG. 1, a facsimile apparatus 1A not only has the same configuration and function as the facsimile apparatus 1 described in the first embodiment, but also has the function of storing a storage location of image data stored in the archive devices 21 and 23 after transmitting or receiving correspond to given information by the operation control. The function is performed by carrying out a series of operation as described later. Additionally, the operation that is described with reference to the flow chart is also carried out on instructions from the CPU 2 based on the control program stored in the ROM 4 of the facsimile apparatus 1A.

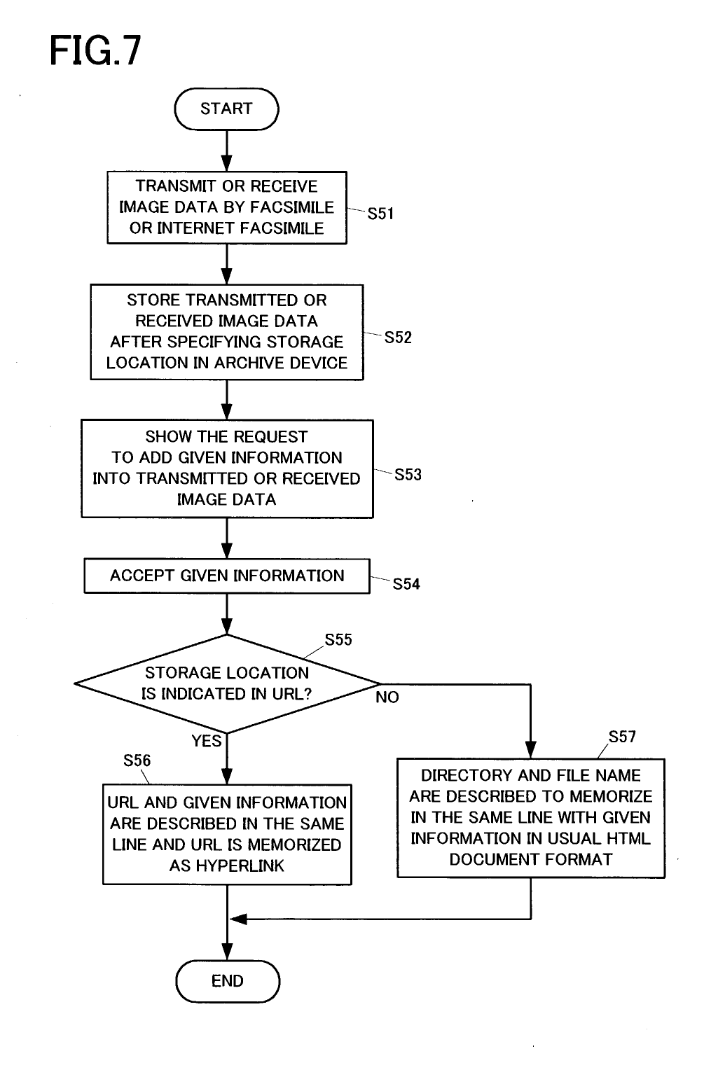

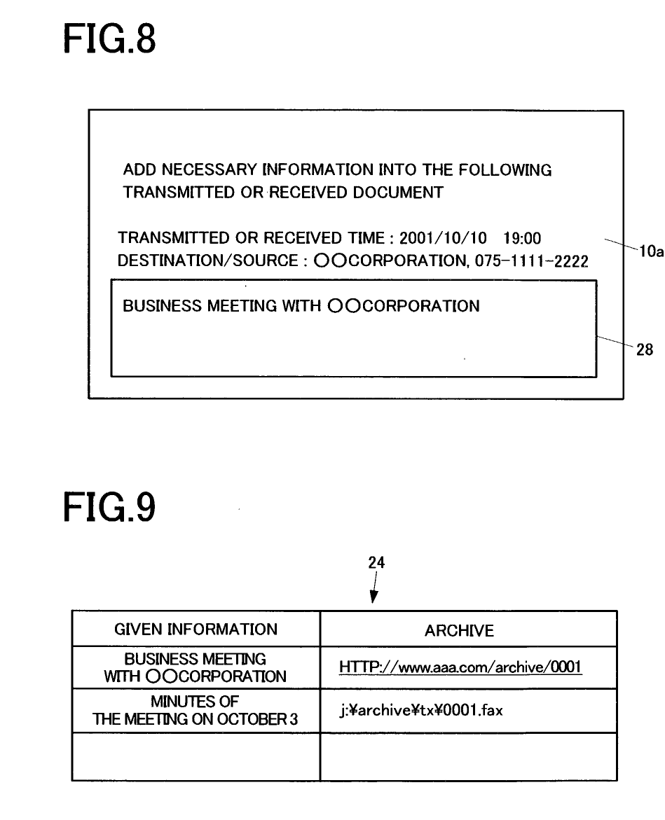

As illustrated in the flow chart of FIG. 7, when transmitting or receiving image data via facsimile or the Internet (S51), a facsimile apparatus 1B stores transmitted or received image data after specifying the HTTP server 21 as an archive device or specifying a URL or a directory and a file name to the file server 23 (S52). As illustrated in FIG. 8, the facsimile apparatus 1B then shows a screen for requesting operators to add given information into the transmitted or received document (image data) stored in the archive device 21 or 23 (S53). When an operator inputs given information with the input field 28, the facsimile apparatus 1A accepts it (S54) and stores the storage location corresponding to given information after an added information file 24 in HTML format indicating a table is formed in a predetermined area of RAM 3 as illustrated in FIG. 9. More specifically, when the image data transmitted or received in S51 is indicated in a URL (S55), the URL and the given information are described in the same line (record) in the table and the URL is stored in hyperlink (S56). Moreover, when the image data is indicated in a directory or a file name (S55), the directory and the file name are described for storing in the same line with the given information in the usual HTML document format (S57).

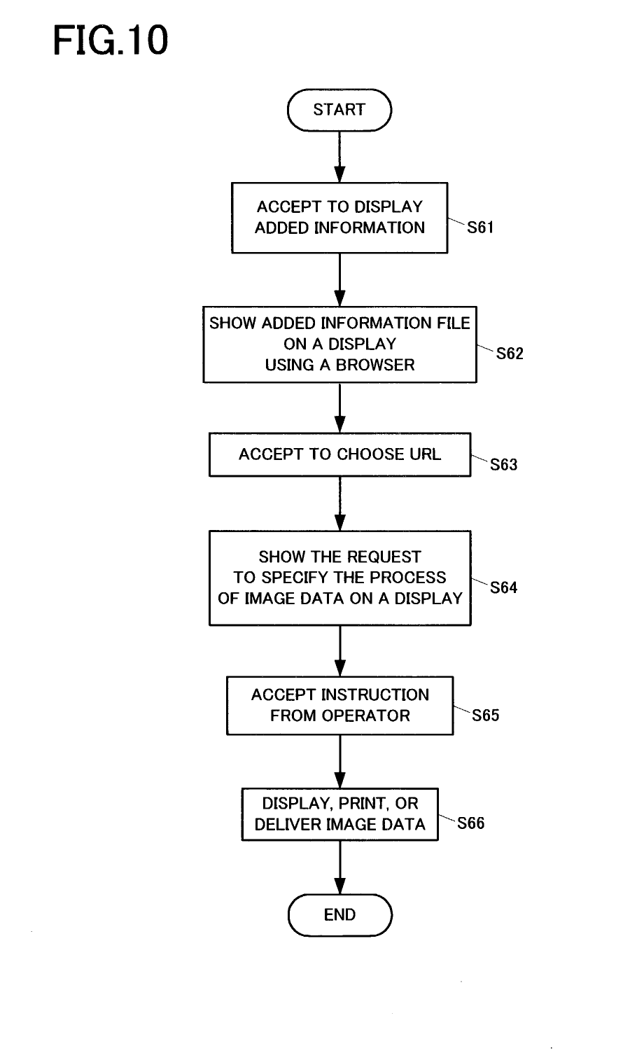

Next, the operation in case that the image data stored in the HTTP server 21 or the file server 23 is displayed, printed, or transferred as described above will be described with reference to the flow chart of FIG. 10. The operation is also carried out on instructions from the CPU 2 based on a control program stored in the ROM 4 in the facsimile apparatus 1A.

First, when an operator operates to display the added information file 24 in the operation unit 10 or the client PC 17, the facsimile apparatus 1A accepts it (S61), and shows the content of the added information file 24 on the display 10a with a browser as illustrated in FIG. 9 or shows the display information on the client PC 17 display by transmitting the information to the client PC 17 (S62).

When a URL in the “archive” field is shown on a screen as hyperlink and an operator chooses the URL by a pointer (not shown in the drawings), the facsimile apparatus 1A accepts it (S63), and shows a screen for requesting operators to specify the process of image data (display, print, or deliver) as illustrated in FIGS. 6A and 6B in the first embodiment or transmits the display information to the client PC 17 so as to show the screen on the client PC 17 display (S64). When accepting the instruction from an operator on screen (S65), the facsimile apparatus 1A processes (display, print, or deliver) the image data on demand (S66).

Additionally, the facsimile apparatus 1A may have the function of transmitting the added information file 24 to a destination requested by an operator in the HTML mail, etc., same as the facsimile apparatus 1 in the first embodiment. Moreover, the facsimile apparatus 1A may have the function of acquiring transmitted or received image data by requiring the data to the file server 23 when an operator operates to choose a directory and a file name shown in the “archive” field of the added information file 24.

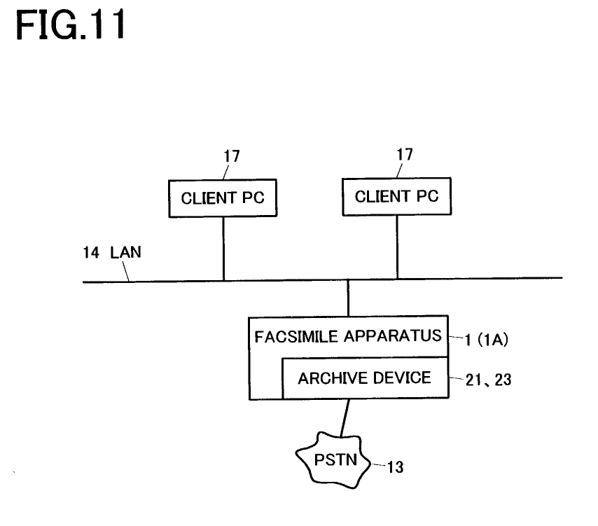

The facsimile apparatus 1 and 1A in the first and second embodiments as described above use the archive devices 21 and 23 installed outside the facsimile apparatus 1 and IA as storage locations of transmitted and received image data. The facsimile apparatus of the present invention may also be arranged so as to achieve the same effect as the first or second embodiment by that the archive devices 21 or 23 are installed in the facsimile apparatus 1 and 1A and the transmitted or received image data is stored and picked up in its own apparatus without using the LAN 14 as illustrated in FIG. 11.

What is claimed is:

1. A facsimile apparatus comprising:
a unit that transmits or receives image data;
a storage unit that stores transmitted and received image data in an archive device located in or out of the facsimile apparatus by specifying a storage location; and
a storage location memory unit that stores an image data storage location corresponding to a record of a communication management log generated in transmitting and receiving image data.

2. The facsimile apparatus as in claim 1, further comprising:
a communication management log output unit that outputs the image data storage location stored by the storage location memory unit corresponding to the record of the communication management log.

3. The facsimile apparatus as in claim 1, wherein the archive device is a HTTP server, the storage location memory unit stores the communication management log and the storage location corresponding to the record of the communication management log as HTML files and also stores the storage location in hyperlink text, and the communication management log output unit outputs the HTML file through a browser.

4. A facsimile apparatus comprising:
a unit that transmits and receives image data;
a unit that stores transmitted and received image data in an archive device located in and out of the facsimile apparatus by specifying a storage location; and
a memory unit that stores given information corresponding to a storage location.

5. The facsimile apparatus as in claim 4, further comprising:
a communication management log output unit that outputs an image data storage location stored by the storage location memory unit corresponding to the record of the communication management log.

6. The facsimile apparatus as in claim 4, wherein the archive device is a HTTP server, the storage location memory unit stores the communication management log and a storage location and given information corresponding to the respective records of the communication management log as a HTTP file and also stores the storage location in hyperlink text, and the communication management log output unit outputs the HTML file using a browser.

7. A facsimile apparatus comprising:
means for transmitting and receiving image data;
means for storing transmitted and received image data in an archive device located in and out of the facsimile apparatus by specifying a storage location; and
means for storing an image data storage location specified by the means for storing transmitted and received image data corresponding to a record of a communication management log generated in transmitting and receiving the image data.

8. The facsimile apparatus as in claim 7, further comprising means for outputting the image data storage location stored by a storage location memory unit corresponding to the record of the communication management log.

9. The facsimile apparatus as in claim 7, wherein the archive device is a HTTP server, the means for storing image data location stores a communication management log and a storage location corresponding to the respective records of the communication management log as a HTML file and also stores the storage location in hyperlink, the facsimile apparatus further comprises a means for outputting the HTML file using a browser.

10. A method for storing image data comprising:
transmitting and receiving image data;
storing transmitted and received image data in an archive device;
generating a communication management log including an image data storage location in the archive device; and
transmitting the communication management log to a remote terminal.

11. The method for storing image data as in claim 10, further comprising storing the image data in a HTTP server.

12. The method for storing image data as in claim 11, further comprising describing the image data storage location as a URL in hyperlink text.

13. The method for storing image data as in claim 10, further comprising storing the image data in a HTTP server.

14. The method for storing image data as in claim 13, further comprising describing the image data storage location as a directory and a file name.

15. A method for storing image data comprising:
transmitting and receiving image data;
storing transmitted and received image data in an archive device;
inputting image information about the image data;
generating a communication management log including an image data storage location and the image information in the archive device; and
transmitting the communication management log to a remote terminal.

16. The method for storing image data as in claim 15, further comprising storing the image data in a HTTP server.

17. The method for storing image data as in claim 16, further comprising describing the image data storage location as a URL in hyperlink text.

18. The method for storing image data as in claim 15, further comprising storing the image data in a HTTP server.

19. The method for storing image data as in claim 18, further comprising describing the image data storage location as a directory and a file name.

20. The method for storing image data as in claim 11, further comprising creating the communication management log as a HTML document.

21. The method for storing image data as in claim 15 further comprising creating the communication management log as a HTML document.
